(19) United States
(12) Patent Application Publication
(10) Pub. No.: US 2008/0081607 A1
(43) Pub. Date: Apr. 3, 2008

(54) METHOD FOR MANAGING CALLS IN A COMMUNICATION NETWORK

(75) Inventors: Philip P. Tangorra, St. Charles, IL (US); Vivek G. Naik, Deerfield, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/536,762

(22) Filed: Sep. 29, 2006

(51) Int. Cl. H04Q 7/20

(52) U.S. Cl. 455/425

(57) ABSTRACT

A method for managing calls of at least one communication device in a communication network (100) is described. The method includes detecting (304) a condition in the communication network (100). The method further includes altering (306) one or more control parameters for existing calls of the at least one communication device. These call control parameters are altered to modify mobility of communication devices in the existing calls within the communication network (100). The method also includes setting up new calls for at least a first class of communication devices by using the altered call control parameters.

### FIELD OF THE INVENTION

This invention relates in general to the field of communication networks, and in particular to managing calls in a communication network.

### BACKGROUND OF THE INVENTION

With an increase in the need for communication and information exchange, communication networks such as computer networks, telecommunications networks and mobile networks are becoming increasingly popular. A communication network includes base stations that are distributed geographically at designated locations throughout an area. These base stations provide coverage to communication devices such as mobile phones, computers, laptops, Personal Digital Assistants (PDAs), mobile computational devices, and the like.

The base stations in the communication network have resources, such as channel bandwidth, to establish calls between the communication devices in the communication network. However, the resources of base stations have constraints, for example, a base station can support only a predefined number of calls at any given time, and the like. At any point of time, there can be a sudden increase in the number of calls in the area pertaining to a base station, due to sporting events or an emergency such as a fire or an accident. In such circumstances, the resources are utilized to their full capacity because they are accessed by a large number of communication devices. This sudden increase in the number of calls may result in overloading of the resources of the communication network. Overloading results in various problems such as lack of connectivity between the communication devices in the communication network, delays in the transfer of data between the communication devices in the communication network, network congestion, and increased access time within the communication network. For example, network overloading in a communication networks may result in lack of connectivity for user communication devices with the base station so that the user cannot access the communication network, increased access time of a target mobile during a call, and so forth.

In existing communication networks, emergency and priority calls may not get connected or may get disconnected while connecting a call during period of overloading. An example of an emergency call can be a call to a fire department when a fire breaks out. An example of a priority call may include a call made by emergency personnel, medical personnel, government officials or the management staff of a stadium during a baseball game during specific times. Since emergency and priority calls are of high importance, providing them with connectivity, even during a period of overloading, is desirable.

One of the existing methods for handling emergency and priority calls during the period of overloading in the communication network is the Persistence Value (PSIST) method, which uses a parameter to randomize the times between access probe sequences when the communication device is making an autonomous access channel request. A large number of call attempts may result in many users attempting to make calls but being unsuccessful in their attempt. The PSIST method overcomes the overload condition by randomly allowing a user to place a call. This results in some users being able to place calls, thereby reducing the number of failed calls, which, in turn, reduces the load on the communication network.

Other methods include managing the calls during the overload condition by reserving a certain bandwidth of the channel for the priority and emergency calls. This ensures that these priority and emergency calls are placed even during the overload condition in the communication network. Another method includes randomly disconnecting non-emergency and non-priority calls, so as to free up the necessary bandwidth for emergency and priority calls.

However, the above-mentioned methods suffer from some of the following limitations. Non-priority and non-emergency calls are randomly disconnected, which often results in customer dissatisfaction. Further, reserving a bandwidth for priority and emergency calls gives rise to unnecessary overhead charges and inefficient utilization of channel capacity during the normal operation of the communication network.

### BRIEF DESCRIPTION OF THE FIGURES

The present invention is illustrated by way of example, and not limitation, in the accompanying figures, where like reference numerals refer to identical or functionally similar elements throughout the separate views, and which, together with the detailed description below, are incorporated, and in which:

FIG. 1 illustrates an exemplary communication network, in accordance with an embodiment of the present invention;

FIG. 2 illustrates a block diagram of a base station, in accordance with an embodiment of the present invention;

FIG. 3 is a flow diagram illustrating a method for managing calls, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In an embodiment, a method for managing calls of at least one communication device in a communication network is provided. The method includes detecting a condition in the communication network. The method further includes altering one or more call control parameters for existing calls of the at least one communication device. These call control parameters are altered to modify mobility of communication devices in the existing calls within the communication network. The method also includes setting up new calls for a first class of communication devices, using the altered call control parameters.

In another embodiment, a base station for managing calls is provided. The base station includes a transceiver and a processor. The transceiver receives information about a condition within a communication network. Based on the information, the transceiver detects one of an overload condition and an expected overload condition in the communication network. The information is based on a state of the communication network. On detecting the overload condition, the processor alters one or more call control parameters of at least one call in the communication network. The one or more call control parameters are altered to modify the mobility of communication devices in the communication network during the overload condition.

Before describing in detail the particular method and system for managing calls in a communication network in accordance with various embodiment of the present invention, it should be observed that the present invention resides primarily in combinations of method steps and apparatus components related to the method and system of managing calls in the communication network. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. Since passive antenna is generally equally effective in reception as it is in radiation, of balanced reciprocity, in the text although not explicitly stated, that the word radiation implies including reception.

The term “another,” as used in this document, is defined as at least a second or more. The term “includes” as used herein, are defined as comprising.

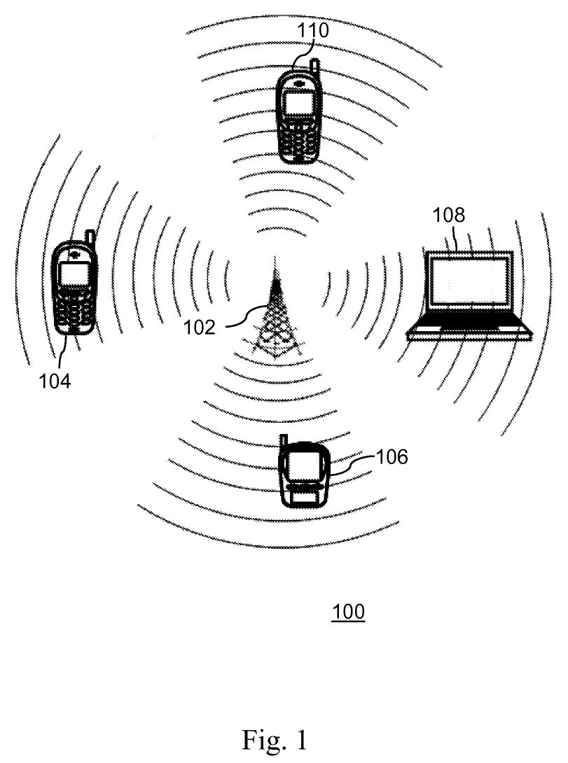

FIG. 1 illustrates a communication network 100, in accordance with an embodiment of the present invention. Examples of the communication network 100 include, but are not limited to, a Code Division Multiple Access (CDMA) network, an Advanced Mobile Phone Systems (AMPS) network, a Global System for Mobile Communications (GSM) network, a Digital Cellular Systems (DCS) network, an Orthogonal Frequency Division Multiplexing (OFDM) network, a Time Division Multiple Access (TDMA) network, Broadband Wireless Access (BWA), WiBB/802.16e and a Universal Mobile Telecommunications Systems (UMTS) network. The communication network 100 includes a base station 102 and communication devices, for example, a communication device 104, a communication device 106, a communication device 108, and a communication device 110. Examples of the base station 102 include, but are not limited to wireless base stations and radio frequency (RF) base stations. Examples of the communication devices 104, 106, 108, and 110 include, but are not limited to, cellular phones, laptop computers, Personal Digital Assistants (PDAs), and messaging devices. The communication devices 104, 106, 108, and 110 communicate with each other through the base station 102. A communication device in the communication network 100 sends a request to the base station 102, to communicate with another communication device in the communication network 100. For example, the communication device 104 sends a request to the base station 102 to establish a communication session, for example, a call with the communication device 106. As shown in FIG. 1, each communication device is associated with at least one base station. In an embodiment of the present invention, the base stations are interconnected through wired or wireless means as a part of network 100.

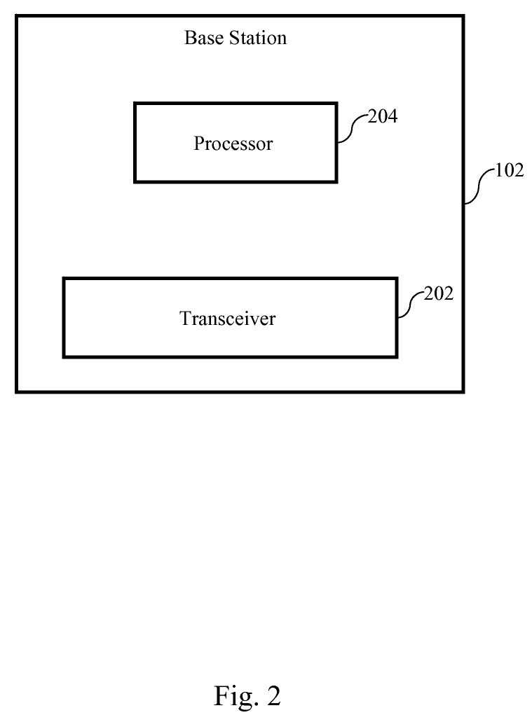

FIG. 2 illustrates a block diagram of the base station 102, in accordance with an embodiment of the present invention. The base station 102 includes a transceiver 202 and a processor 204 and other components known by those of skill in the art. The transceiver 202 is one known by those of skill in the art to transmit and receive voice and data signals between base stations and communication devices as part of the operations of network 100. The transceiver 202 can also receive information about a condition within the communication network 100. Based on the information it receives, the transceiver 202 can detect an overload condition or an expected overload condition in the communication network 100. In an embodiment, the overload condition or the expected overload condition may be a condition in which the resources of the communication network 100 are over-used and fully occupied because of simultaneously being accessed by a large number of communication devices. For example, the overload condition can be a large number of calls to a fire department when a fire breaks out or another type of emergency situation. In an embodiment, the transceiver 202 can also transmit a notification pertaining to the overload condition and the expected overload condition to the communication devices 104, 106, 108, and 110. The base station 102, through the transceiver 202 can send the notification to certain classes of communication devices. In an embodiment, the notification is sent to all the communication devices 104, 106, 108, and 110 within the range of the base station 102. In an alternative embodiment, the notification is sent to a subset of communication devices such as non-priority and non-emergency devices or other subsets of the communication devices whose parameters can be changed in response to receiving the notification.

The processor 204 alters one or more call control parameters for at least one call in the communication network 100. In an embodiment, these one or more call control parameters are altered to modify the mobility of the communication devices in the communication network 100. Examples of the one or more call control parameters may include, number of traffic channels assigned during a call set up, a traffic channel add threshold, a traffic channel drop threshold, an allowed number of traffic channels per call, a predefined Frame Error Rate (FER), a power-link mode, and a number of handoff candidates. In an embodiment of the present invention, calls in the communication network 100 can be either a first class of calls or a second class of calls, based on the communication device making the call. The first class of calls (“non-PEC calls”) includes non-priority and non-emergency calls made by any communication device 104-110. The second class of calls (“PEC calls”) includes priority and emergency user calls (PECs). PEC calls can be made by any communication device 104-110 for making emergency calls and for calls made by PEC personnel during given situations. Typically, these PEC calls originate from or are destined for a location related to an emergency situation. Typically, a second class of communication devices can be communication devices configured as PEC communication devices for the PEC personnel. For example, the PEC communication device may belong to a rescue operation worker. Hereinafter, the communication devices corresponding to the non-PEC calls will be referred to as the non-PEC communication devices, and those corresponding to the PEC calls will be referred to as the PEC communication devices. In an example, calls originating from the PEC communication devices can be calls made to an ambulance station from an area hit by a hurricane. The emergency calls from the PEC communication devices can be further distinguished on the basis of features such as the location and destination of the calls, and the like. In an embodiment of the present invention, the processor 204 is capable of distinguishing a first class calls from a PEC calls as well as PEC and non-PEC communication devices.

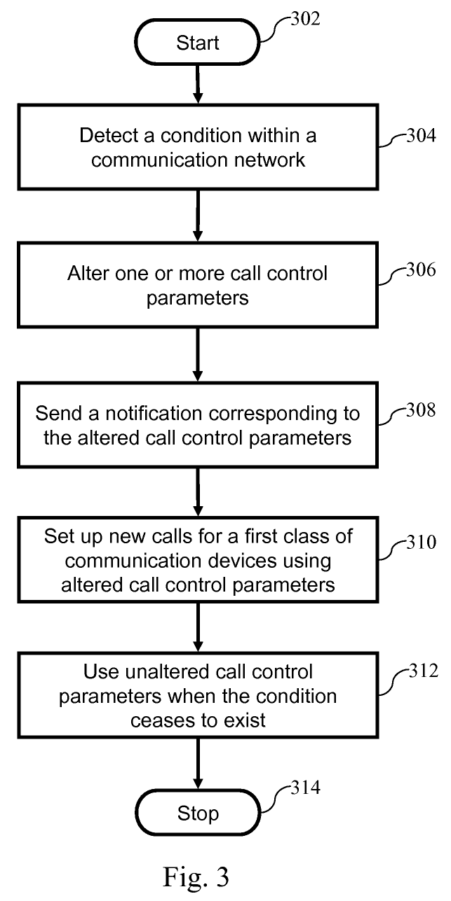

FIG. 3 is a flow diagram illustrating a method for managing calls in a communication network 100, in accordance with an embodiment of the present invention. At step 302, the method is initiated. At step 304, a condition, such as, an overload condition or an expected overload condition within the communication network 100, is detected by the transceiver 202. The condition of the communication network 100 is based on a state of the network. Examples of the state of the communication network 100 may include the number of users in the communication network 100, the average number of traffic channels, the number of calls, the percentage increase in the number of calls, and so forth. For example, there may be a sudden increase in the number of calls because of an emergency situation such as an accident. Typically, the overload condition is determined, based on a threshold of the number of calls within an area. For example, in an embodiment of the present invention, the base station 102 can have a threshold for the maximum number of calls it can support, or a maximum bandwidth limit, and the like. When the threshold is crossed, the base station 102 is overloaded. In an alternative embodiment, it is possible for a PEC communication device to designate to the network an overload condition or the network condition on which mobility of devices within the network should be limited or modified.

In an embodiment of the present invention, the transceiver 202 carries out a periodic check for the overload condition and any change in the overload condition in the communication network 100. Examples of the expected overload condition may arise due to a sudden increase in the number of calls in any service area of the base station 102, in a short time span, caused by an emergency situation such as a fire, an accident, and the like. Although the number of calls is below the threshold, the rate of increase can be very high, which may ultimately result in an overload condition. This expected overload condition requires preemptive action to be taken, to avoid an overload condition. Alternatively, PEC communication devices can originate from a location related to an emergency or are destined for such a location thereby making the call a PEC call. PEC calls can be made by PEC and non-PEC communication devices.

At step 306, the processor 204 alters one or more call control parameters for existing calls and new calls of the non-PEC calls in the communication network 100. The existing calls of the non-PEC calls include calls made prior to the detection of the overload condition or the expected overload condition. The new calls of the first class include calls initiated after the detection of the overload condition or the expected overload condition.

In an embodiment of the present invention, the non-PEC calls include non-priority and non-emergency calls. These non-priority and non-emergency calls can be calls that do not originate from location related to an emergency or are destined for a location related to an emergency such as an accident, a fire, and so forth. These non-priority and non-emergency calls can be calls that are not associated with PEC mobile communication devices.

In an embodiment of the present invention, altering the one or more call control parameter includes modifying the mobility of the non-PEC communication devices within the communication network 100. Modifying the mobility includes reducing mobility or quality of communication session setup for the communication devices, such as reducing the number of traffic channels for communication and modifying the traffic channel-add threshold, the traffic channel-drop threshold, the allowed number of traffic channels per call, the predefined FER, the power link mode, and the number of handoff candidates. Restricting the mobility implies limiting the connectivity of the communication devices within a region, for example, the communication network does not maintain the connectivity of a call as the communication devices moves throughout the network 100 and the call has to be handed over to another base station in a manner known by those of skill in the art.

At step 308, a notification is sent corresponding to the altered call control parameters pertaining to the condition of the communication network 100. The notification is sent to the communication devices being affected by the altered call control parameters. In an embodiment of the present invention, the base station 102, through the transceiver 202 notifies the communication devices about the modified mobility caused by the condition. The condition includes at least one of a present overload condition and an expected overload condition. Typically, the base station 102 provides information to the communication devices about the present overload condition and the expected overload condition. In an alternative embodiment it is possible for the Priority and Emergency Call (PEC) communication device to designate to the communication network 100 an overload condition. The notification about the present overload and the expected overload condition can be achieved by sending a message from the base station to the communication devices. In an embodiment of the present invention, the notification can be indicated to the communication devices in the form of a text message, a flicker, an icon display, a vibration, a beep, a voice message, and so forth. In an embodiment of the present invention, the communication devices are notified when the condition ceases to exist.

At step 310, new calls of the non-PEC calls, corresponding to non-PEC communication devices, are set up using the altered call control parameters in the communication network 100. The new calls include the calls established after the condition has been detected by the transceiver 202 of the base station 102.

A set of new PEC calls can be initiated for the PEC communication devices using unaltered call control parameters. The PEC calls include priority and emergency user calls (PECs). Typically, PEC calls originate from a location related to an emergency or are destined for a location related to an emergency. In an embodiment of the present invention, the second class of call is an emergency call. Emergency calls can be made by PEC mobile communication devices or non-PEC devices that make specific calls to 911 services or other designated numbers. In an embodiment, the emergency calls from the PEC communication devices include the calls originating or destined for an emergency location or those related to an emergency situation. In an embodiment of the present invention, a tiered control mechanism can be used for the PEC communication devices whereby the communication network 100 includes setting up a first set of new calls for the PEC communication devices using unaltered call control parameters and the second set of PEC calls made by non-PEC communication devices.

In another embodiment of the invention, a second set of new calls for the PEC communication devices can be setup using new set of call control parameters when the number of calls belonging to the first set of new calls from the PEC communication devices exceeds a threshold. The second set of new calls for the PEC communication devices can be based on parameters such as, activity, origination parameters, and the like. The new set of call control parameters for the second set of new calls can be different from the call control parameters and the altered call control parameters.

At step 312, the communication network 100 reverts to the unaltered call control parameters for all the existing calls, and the new calls when the condition ceases to exist. All the existing and the new calls include the first class of class and the second class or calls. This may occur when the overload condition is no loner detected or when a PEC communication device indicates to the network that the there is no need to maintain the altered conditions. The method terminates at step 314.

In another embodiment of the present invention, the method includes handling an overload condition in the communication network 100. In this embodiment, the processor 204 alters one or more call control parameters for existing calls from the PEC calls in the communication network 100. Typically, the communication network 100 uses the unaltered call control parameters for the second class of new and existing calls when the overload condition ceases to exist.

In another embodiment of the present invention, the method includes handling an overload condition in the communication network 100. In this embodiment, the processor 204 alters one or more call control parameters for existing calls from the non-PEC calls in the communication network 100. Typically, the communication network 100 uses the unaltered call control parameters for the existing calls, of the first class when the overload condition ceases to exist.

Therefore, it should be clear from the preceding disclosure that the present invention provides a method for managing calls in a communication network 100. As per the present invention the method removes the need for reserving a bandwidth for priority and emergency calls. This results in an efficient utilization of channel capacity during the normal operation of the communication network 100. Further as per the method provided, the non-priority and non-emergency calls are not randomly disconnected in the communication network 100 to handle emergency conditions.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing calls of at least one communication device in a communication network, the method comprising:
detecting a condition within the communication network;
altering one or more call control parameters for existing calls of the at least one communication device, wherein the one or more call control parameters are altered to modify mobility of the at least one communication device in the existing calls within the communication network; and
setting up new calls for a first class of communication devices using the one or more altered call control parameters.

2. The method of claim 1 further comprising setting up a first set of new calls for a second class of communication devices using unaltered call control parameters.

3. The method of claim 1 further comprising setting up a second first set of new calls for a second class of communication devices using new set of call control parameters when number of calls from the second class of calls exceeds a threshold.

4. The method of claim 3 wherein the new set of call control parameters is different from the unaltered call control parameters and the at least one altered call control parameters.

5. The method of claim 3 wherein the second class of call is an emergency call.

6. The method of claim 1 wherein the condition comprises at least one of an overload condition and an expected overload condition in the communication network.

7. The method of claim 1 further comprising notifying the at least one communication device of the condition and any change in the condition thereof in the communication network.

8. The method of claim 1 further comprising using unaltered call control parameters for the existing calls and the new calls when the condition cease to exist.

9. The method of claim 1, wherein the at least one call control parameter is selected from a group comprising a number of traffic channels assigned during call set up, a traffic channel add threshold, a traffic channel drop threshold, an allowed number of traffic channels per call, a predefined Frame Error Rate (FER), a power link mode, and a number of handoff candidates.

10. A method for handling an overload condition in a communication network, the communication network comprising one or more communication devices, the method comprising:
detecting a condition within the communication network;
altering one or more control parameters for existing calls and new calls in the communication network, wherein the one or more call control parameters are altered to modify mobility of the one or more communication devices in the existing calls and the new calls within the communication network; and
setting up a first set of new calls in the communication network using unaltered call control parameters.

11. The method of claim 10 wherein the modified mobility reduces quality of mobility of the one or more communication devices within the communication network.

12. The method according to claim 10 wherein altering the one or more control parameters for the existing calls and the new calls in the communication network is done by a processor.

13. The method of claim 10 further comprising notifying the one or more communication devices about the modified mobility

14. The method of claim 10 further comprising periodically checking the condition and any change in the condition thereof in the communication network.

15. The method of claim 10 further comprising using unaltered call control parameters for the existing calls and the new calls when the overload condition ceases to exist.

16. The method of claim 10 further comprising using a new set of call control parameters for a second set of new calls when number of calls of the first set of new calls exceeds a threshold.

17. The method of claim 10, wherein the call control parameters are selected from a group comprising a number of traffic channels assigned during call set up, a traffic channel add threshold, a traffic channel drop threshold, an allowed number of traffic channels per call, a predefined Frame Error Rate (FER), a power link mode, and a number of handoff candidates.

18. A base station for managing calls in a communication network, the base station comprising:
a transceiver configured to receive information about a condition within the communication network, and to detect one of an overload condition and an expected overload condition based on a state of the communication network; and
a processor capable of altering one or more call control parameters for at least one call in the communication network, wherein the one or more control parameters are altered to modify mobility of communication devices in the communication network.

19. The base station of claim 18, wherein the processor is further capable of distinguishing between a first class of calls and a second class of calls.

20. The base station of claim 18, wherein the transceiver is further capable of notifying the communication devices about at least one of the overload condition and the expected overload condition in the communication network.
